(19) United States
(12) Patent Application Publication
(10) Pub. No.: US 2012/0004060 A1
(43) Pub. Date: Jan. 5, 2012

(54) SPROCKET CHAIN

(75) Inventors: Klaus Hahn, Fuerth-Burgfarrnbach (DE); Bolko Schuseil, Adelsdorf (DE)

(73) Assignee: SCHAEFFLER TECHNOLOGIES GMBH & CO. KG, (DE)

(21) Appl. No.: 13/201,089

(22) PCT Filed: Feb. 12, 2010
(86) PCT No.: PCT/EP2010/051765

§ 371 Date: Aug. 11, 2011

(30) Foreign Application Priority Data
Feb. 18, 2009 (DE) 10 2009 009 526.8

(51) Int. Cl. F16G 13/06

(52) U.S. Cl. 474/228

(57) ABSTRACT

A sprocket chain formed by several pivotally interconnected chain links that have at least one central plate and at least two cover plates which are arranged on both sides of the central plate. The cover plates and the central plate are interconnected using at least two connecting members. The chain links also have inner plates which are arranged between the cover plates and the central plate and pivotally interconnect the chain links. At least two inner plates are provided between the central plate and the cover plates. The ratio between the total width of the stack of inner plates, i.e. the sum of the widths of the inner plates, and the width of the central plate is greater than or equal to 1.3.

### FIELD OF THE INVENTION

The invention relates to a sprocket chain formed by a plurality of chain links which are connected pivotably to one another, having at least one center link plate and at least two cover link plates which are arranged on both sides of the center link plate, the cover link plates and the center link plate being connected to one another via at least two connecting elements, and having inner link plates which are arranged between the cover link plates and the center link plate, which inner link plates connect the chain links to one another pivotably.

Sprocket chains of this type are frequently used in motor vehicles and serve there as control drive and assembly drive in the internal combustion engine. In one application, the sprocket chain wraps around the crankshaft, which is the driving shaft here, and at least one camshaft or one camshaft adjuster, which is the driven shaft here, and transmits the rotational movement of the crankshaft to the camshaft as a result. In order to transmit the rotational movement, the inner link plates have, in particular, tooth-like inwardly and/or outwardly directed projections which engage into corresponding receptacles of the drive pulleys of the driving and the driven shafts.

The center link plates are connected fixedly to the connecting elements so as to rotate with them, which connecting elements are preferably configured as pins, and said center link plates serve to transmit the pulling force within the chain links. The cover link plates are arranged on both sides of the center link plates and laterally cover the link plate assemblies which are formed by the center link plates and the inner link plates. Together with the cover link plates and the connecting elements, the center link plates form the chain links of the sprocket chain.

The inner link plates are arranged between the center link plates and the cover link plates and connect the chain links among one another. Here, the inner link plates are held pivotably on the connecting elements with play. On account of the pivotable arrangement of the inner link plates, the chain links can be pivoted among one another, with the result that the chain is movable and can be adapted to different courses between the driving and the driven shafts.

In order that the sprocket chain can fulfill its function, different link plates with different functions have to be provided accordingly. Here, in particular, the rotationally fixed arrangement of the center link plate on the connecting elements has proven appropriate, since, as a result, the pulling forces can be transmitted without wear within the chain links and the service life is increased substantially as a result. A further important aspect of the design of the sprocket chain is the active articulation surface between the inner link plates and the connecting elements, which articulation surface should be selected to be as large as possible for the sake of a high service life of the sprocket chain.

It is an object of the invention to provide a sprocket chain with a long service life and at the same time low production costs.

The object is achieved by a sprocket chain having the features of claim 1. Advantageous developments of the invention are specified in the subclaims.

In order to achieve the object, it is proposed that in each case at least two inner link plates are provided between the center link plate and the cover link plates, and the ratio of the overall width of the inner link plate assembly, formed from the sum of the widths of the inner link plates, to the width of the center link plate is greater than or equal to 1.3. The active articulation surface between the inner link plates and the connecting elements is therefore increased considerably, it being possible for the width of the individual inner link plates to be selected by the use of at least two inner link plates in such a way that production of the inner link plates is possible in an inexpensive standard punching process.

A further increase in the active articulation surface can be achieved by the fact that the inner link plates have apertures, via which the inner link plates are held pivotably on the connecting elements, the inner link plates are configured as punched parts and are subsequently cut in the region of the apertures. The flush cut proportion can be increased further by the subsequent cutting, so that the articulation surface is increased by approximately 30% as a result.

The width of an inner link plate should preferably be smaller than the width of the center link plate. Since the center link plate is connected fixedly to the connecting element so as to rotate with it, it has no articulation function and can be of correspondingly wide dimensions in accordance with its main function, to transmit the pulling forces which occur in the chain link. Furthermore, for the purpose of assembly outlay which is as low as possible, only one center link plate should be used which, for example, is connected to the connecting element fixedly in terms of rotation by a press fit and additionally fixedly in the displacement direction on said connecting element. Since the inner link plates are held pivotably on the connecting elements with play, the assembly outlay per inner link plate is comparatively smaller, with the result that the use of thinner inner link plates which can be punched inexpensively is appropriate here. A plurality of inner link plates can be used, in order that the active pulling forces are transmitted between the chain links; two or more inner link plates should preferably be arranged on both sides of the center link plate.

It has been proven that the inner link plates and the center link plate fulfill their function particularly satisfactorily with production costs for the sprocket chain which are as low as possible if the width of the inner link plates is 1.2-1.7 mm, preferably 1.5 mm, and the width of the center link plate is 2.0-2.5 mm, preferably 2.3 mm.

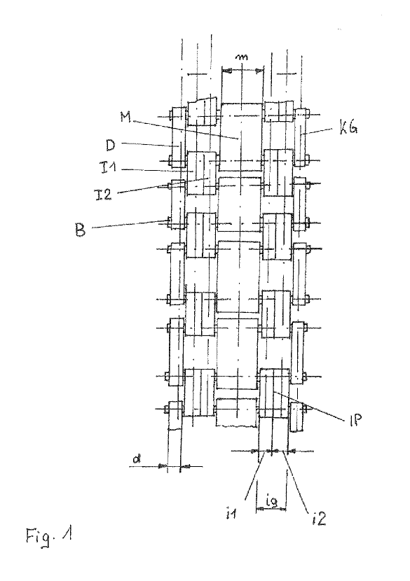

In the following text, the invention will be explained in greater detail using the single FIG. 1.

FIG. 1 shows a plan view of a sprocket chain according to the invention.

In FIG. 1, a sprocket chain can be seen which is assembled from a plurality of chain links KG. Each chain link KG is formed from a center link plate M, two cover link plates D which cover the chain links KG on the edge side, and two connecting elements B which are configured as pins. The center link plates M are connected fixedly to the connecting elements B so as to rotate with them and have the task of transmitting the active pulling forces within the chain links KG. To this end, the center link plates M are preferably pressed together with the connecting elements B, with the result that they are secured in a rotationally fixed manner on the connecting elements and additionally are secured against lateral sliding. Furthermore, in each case two inner link plates I1 and I2 are held pivotably on the connecting elements B on both sides of the center link plates M, which inner link plates I1 and I2 connect the chain links KG among one another. On account of the pivotability of the inner link plates I1 and I2, the chain links KG are configured such that they can likewise be pivoted relative to one another, with the result that the sprocket chain overall can be adapted to different courses between the driving and the driven shafts.

In the exemplary embodiment which is shown, the width m of the center link plate M is 2.3 mm, the widths i1 and i2 of the inner link plates I1 and I2 are in each case 1.5 mm, and the width d of the cover link plates D is 0.9 mm. This results overall in an overall width g of the link plate assembly of 10.1 mm, in the case of a number of seven individual link plates.

Overall, accordingly, the center link plate M is the widest individual link plate and absorbs the greatest pulling forces, while at least two of the inner link plates I1 and I2 are provided on both sides of the center link plate M, with the result that they can be of somewhat thinner design despite the high pulling forces to be transmitted, without their loading limit being exceeded. The cover link plates D are finally the thinnest individual link plates, since their actual task does not comprise the transmission of pulling forces, but rather covering the chain links laterally and ensuring the cohesion of the chain links.

On account of the proposed width ratios, the inner link plates I1 and I2 can be punched inexpensively, it being possible nevertheless for a sufficiently large articulation surface to be realized for a long service life of the sprocket chain, as a result of the selection of a correspondingly large amount of inner link plates. If required, the inner link plates which are produced in the standard stamping process can be subsequently cut at least in the region of the apertures, via which the inner link plates I1 and I2 are mounted pivotably on the connecting elements B, with the result that the flush cut proportion and the articulation surfaces are increased further.

1-4. (canceled)

5. A sprocket chain, comprising:
a plurality of chain links connected pivotably to one another, the chain links each having at least one center link plate, at least two cover link plates arranged on both sides of the center link plate, at least two connecting elements connecting the cover link plates and the center link plate, and at least two inner link plates forming an inner link plate assembly, each of the inner link plates having a first end, a second end and widths forming an overall width of the inner link plate assembly, and the inner link plates being arranged between the cover link plates and the center link plate for connecting pivotably one of the chain links at the first end of each of the inner link plates to a subsequent chain link at the second end of each of the inner link plates,
wherein a ratio of the overall width of the inner link plate assembly to a width of the center link plate is greater than or equal to 1.3.

6. The sprocket chain as claimed in claim 5, wherein the inner link plates each have apertures and the apertures hold the inner link plates pivotably on the connecting elements.

7. The sprocket chain as claimed in claim 6, wherein the inner link plates are punched parts that are cut in a region of the apertures.

8. The sprocket chain as claimed in claim 5, wherein a width of each of the inner link plates is smaller than the width of the center link plate.

9. The sprocket chain as claimed in claim 8, wherein the width of each of the inner link plates is 1.2-1.7 mm and the width of the center link plate is 2.0-2.5 mm.

10. The sprocket chain as claimed in claim 8, wherein the width of each of the inner link plates is 1.5 mm and the width of the center link plate is 2.3 mm.
